(19) United States
(12) Patent Application Publication
(10) Pub. No.: US 2015/0317960 A1
(43) Pub. Date: Nov. 5, 2015

(54) TAILPIECE WITH SUSPENSION SYSTEM FOR ARCHTOP GUITARS

(71) Applicant: Vasileios Frementitis, Patras (GR)

(72) Inventor: Vasileios Frementitis, Patras (GR)

(73) Assignee: Vasileios Frementitis, Patras (GR)

(21) Appl. No.: 14/699,239

(22) Filed: Apr. 29, 2015

(30) Foreign Application Priority Data
Apr. 29, 2014 (GR) 20140100243

(51) Int. Cl. G10D 3/12

(52) U.S. Cl. CPC G10D 3/12

(57) ABSTRACT

The invention regards the mode in which the strings are supported through the tail on the acoustic archtop guitars.

A suspension system (15b) of the strings with or without handle-tremolo (13), necessary for easy playing, placed in such a way that the tail (11) does not come into contact with the top (17) of the guitar, and thus its sound is not harmed.

This tailpiece may be placed on acoustic archtop guitars but also on any other arched guitar.

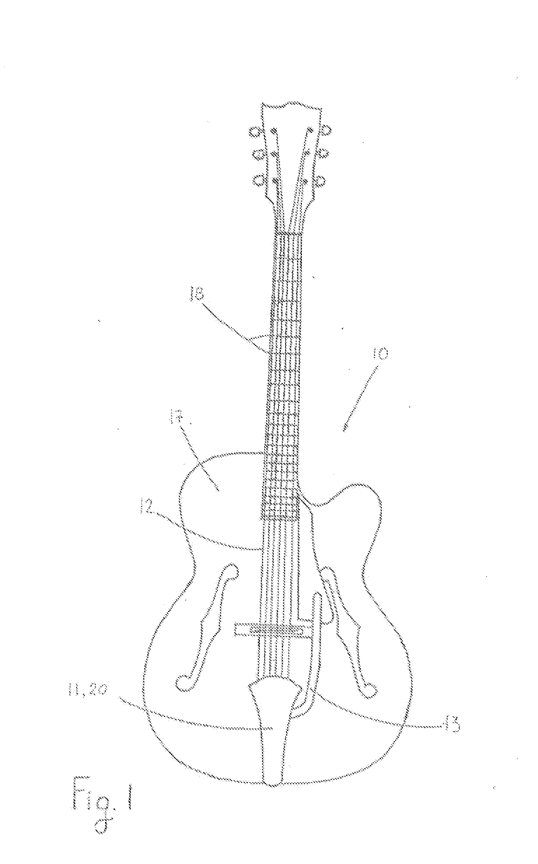

The invention regards a mode of supporting the strings (12) on the body of an acoustic archtop guitar (10) (FIG. 1) (or jazz guitar) making use of a tail (11) (or vignette, tailpiece).

There are two basic methods for supporting the strings by means of the tail, and these are the following:

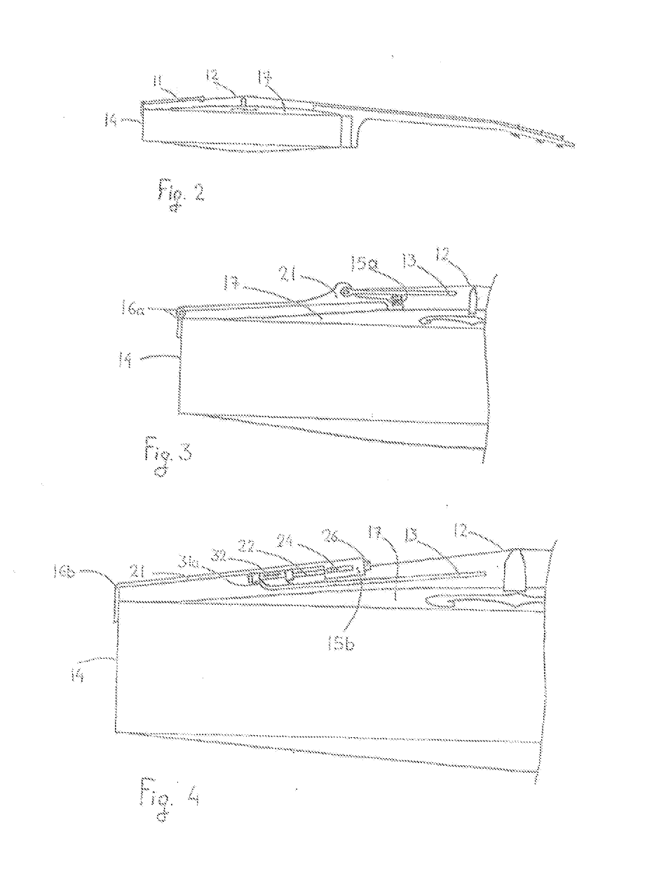

1. Support of the strings through a wooden or metallic tail on the side (14) of the guitar (FIG. 2). Here, the tail is used mainly as an extension of the strings up to the side (14) of the guitar.

2. Support of the strings through the metallic tail with suspension system (15) and handle-tremolo (13) (FIG. 3). The tail is supported on both the side part (14) of the guitar with joint (16a) and the upper top (17) of the guitar, through the suspension system (15a) either with contact or firmly bolted.

In the first method, in which the tail is supported only on the side (14) of the guitar, the top (17) of the guitar is free to vibrate through the picking of the strings in order to produce sound. As regards this issue, the first method has an advantage over the second one, in which the tail touches the top or is bolted on the top (17) of the guitar, through the suspension system (15a) transferring—perpendicular to it—part of the pressure of the strings, but also the weight of the tail. Because of this, an additional internal reinforcement is required on the top (17) of the guitar to withstand the pressure, causing destructive effect on the sound. The weight of the tail of the second method is much higher than the first, since the pressure of the strings is transferred to the body of the guitar via a single bulky spring (FIG. 3), which requires a heavy construction of the tail.

The advantage of the second method in connection with the first is that the existence of the suspension system (15a) makes it easier to play the guitar because less finger pressure is required on the string to get in contact with the fret (18) (FIG. 5). This is because with the pressure of the finger the suspension system (15a) is retracted, reducing the tension of the string, and thus the necessary pressure of the finger. Furthermore, with the existence of the handle (13) attached to the suspension system (15a) the guitarist can even by himself increase or decrease the tension of the strings, by moving the handle (13) which involves varying the frequency of the sound produced (tremolo).

In the second method, that is, the existence of the suspension system (15) in the tail is superior to the first one in terms of usefulness of the guitar, but by damaging the sound. In contrast, in the first method where the tail is based only on the side (14) of the guitar, the sound is not harmed but the method does not contribute to its utility either.

Due to the particularities of these two methods for the support of the strings, the archtop guitars are divided into two categories. The first category includes acoustic archtop guitars, where the strings are supported only according to the first method. The second category includes electric archtop guitars, in which both supporting methods are used (electric archtop guitars have a thick top plate and they collect the sound from the strings using electric means).

In this invention the second method of mounting is used, with the difference that here the suspension system (15b) is moving parallel to the direction of the tail and the strings, without the tail touching the top plate (17) of the guitar. Moreover, the suspension system (15b), which can be connected to a metallic handle (13) producing the manual tremor, transfers the pressure of the strings and at times of the hand (tremolo) through six small springs (27) (light construction) only on the side of the (14) guitar. For the construction of the tail, titanium alloy (Ti6Al4V) is used, to further reduce the weight and to increase the strength in bends.

An advantage of this invention is that the tail is bearing a suspension system (15b) allowing to accommodate the handle-tremolo (13). This system makes it easier to play the guitar on the one hand, while, because it does not contact the top (17) of the guitar nor is it heavy, it is not detrimental to tis sound.

For the illustration and explanation of the invention eight figures are given:

FIG. 1 shows a plan view of the archtop guitar (10) and the tail (11) is covered with wooden decorative top (20).

FIG. 2 is a side view of the guitar showing the first method for supproting the strings (12) on the tail (11). The tail is only supported on the side (14) of the guitar.

FIG. 3 is a part of the side view of the guitar showing the second method for supporting the strings (12) on the tail. The tail is supported on the side (14) of the guitar and the top (17) of the guitar.

FIG. 4 is a part of the side view of the guitar showing the invention for the supporting of the strings (12) on the tail (11) and the handle-tremolo (13). The tail is only supported on the side (14) of the guitar.

FIG. 5 shows the way in which the string (12) contacts the frets (18), following the pressure exerted by the finger of the guitarist.

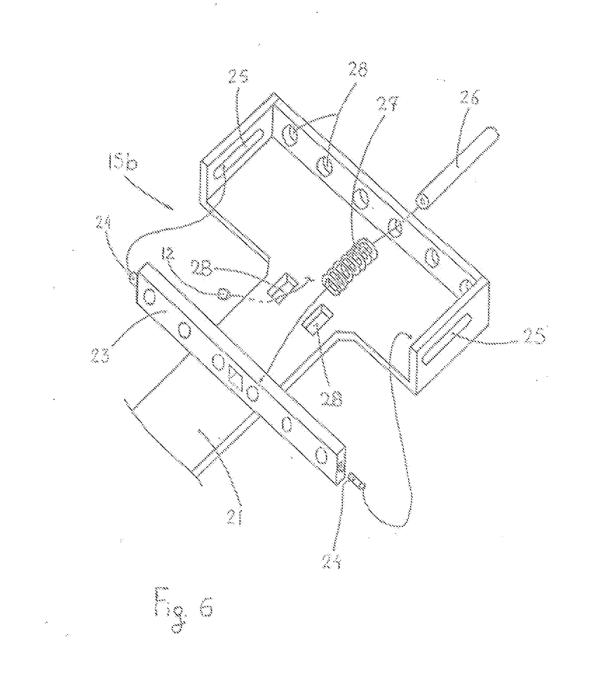

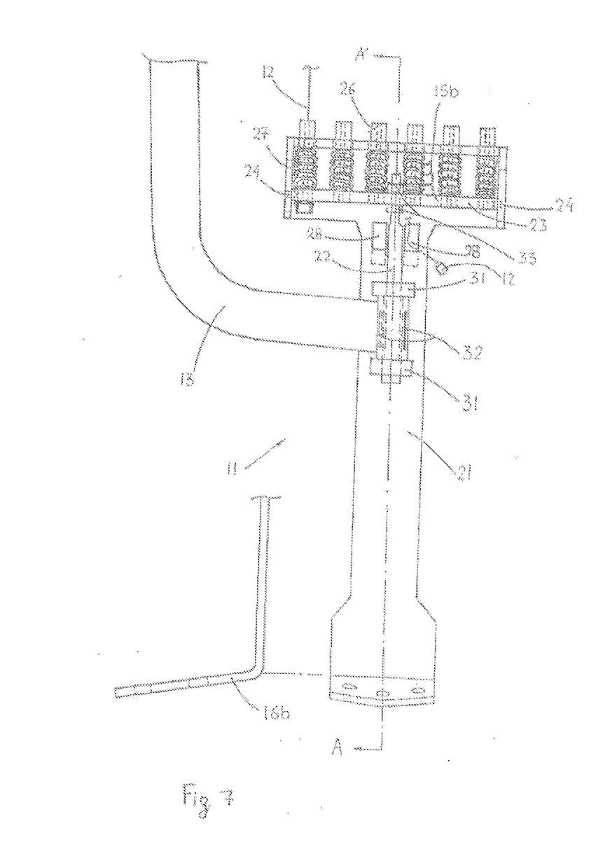

FIG. 6 shows the mode to assemble the suspension system (15b). The metallic rod (23) along with the metallic tubes (26) and metallic springs (27) are inserted in the metallic frame (21). Following that, the metallic pins (24) are bolted at the ends of the metallic rod (23) and they become the guides of the train set on the metallic frame (21).

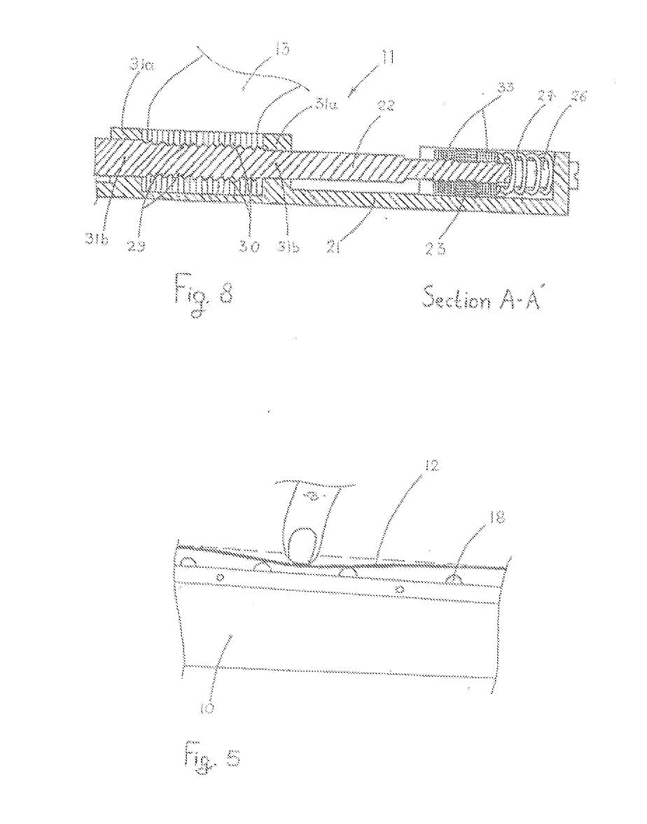

FIG. 7 shows the plan view of the tail (11) with the suspension system (15b), the strings (12) and the handle—tremolo (13). Moreover the 100 degrees angle of the tail (11) is shown in order to connect it to the side (14) of the guitar.

FIG. 8 shows part of the section of the tail (11) A-A′.

The invention is described here-below with the help of an example and with reference to the attached figures: 6,7 and 8. To facilitate the reading of the aforementioned figures, the tail (11) has been designed with its lower part upside.

As we see in FIGS. 6, 7 and 8, the tail consists of a metallic frame (21) bearing a connection angle (16b) with the side part (14) of the guitar. Moreover, it is bearing a suspension system (15b) which is moving in parallel to the direction of the tail and the strings. Moreover, it can be bearing a metallic handle-tremolo (13) connected, through a metallic axis (22), to the suspension system (15b). Finally, the tail is covered by the detachable wooden top (20) for aesthetic reasons.

In detail, the suspension system (15b) consists of a metallic rod (23), which through the two pins (24) at its ends is drawn to the respective grooves (25) of the metallic frame (21). On the metallic rod (23) six metallic tubes (26) are anchored perpendicularly and through them the strings are passing and anchored on the side of the metallic rod (23). The free ends of the six metallic tubes (24) are passing respectively through six holes (28) of the metallic frame (21). The six metallic tubes (24) are entering six pressure metallic springs (27) respectively. Metallic springs (27) are found between the metallic rod (23) and the metallic frame (21) and are divided into three pairs of different hardness degree. The placement of the springs starts from springs of lower hardness degree on strings of smaller intersection and continues with the springs of higher hardness degree on the springs with a larger intersection. In this way the simultaneous displacement of the metal rod is achieved, as the tension of the strings is different because of the different intersection.

Hence, the metallic frame (21) through the metallic rod (23) and the metallic springs (27) transfers the pressure of the strings on the side (14) of the guitar, creating a suspension system (15β).

The suspension system (15b) may be connected to the metallic handle-tremolo (13). This is achieved by the use of a metallic axis (22) connecting the metallic rod (23) with the metallic handle (13). The metallic axis (22) is firmly bolted in the middle of the metallic rod (23) with two nuts (33) and its other end, through an external screw head (29), is adapted to the respective internal screw head (30) of the metallic handle (13). That means that the metallic axis (22) crosses, through the screw head (29, 30) the metallic handle (13). Moreover, it crosses two fixed points (31) of the metallic frame (21) with which the metallic handle (13) comes into contact, allowing only its rotary motion around the metallic axis (22). That implies (due to the screw head) that the movement (rotary) of the metallic handle (13) shifts at the same time the metallic rod (23) altering the frequency of the sound produced (tremolo).

The metallic rod (13) at the point of its rotation bears two projections (stops) (32) with which the angle of its rotation is defined. Moreover, when the guitar is tuned, with the two nuts (33) used to tighten the metallic axis (22) on the metallic rod (22), the operational angle of the metallic handle-tremolo (13) is set with precision.

Finally, after having removed the wooden top (20), the six strings are entering the metallic tubes (26) from the side of the metallic rod (23) and the two of them found in the middle cross the metallic frame (21) through the respective holes (28).

1. Tailpiece (11) for the support of strings (12) on an acoustic archtop guitar (10). The tailpiece (11) consists of a metallic frame (21), which is supported on the guitar, and on the same, through a suspension system (15b), the strings are supported (12). The suspension system (15b) is connected with a metallic handle—tremolo (13) placed on the metallic frame (21).
The tailpiece (11) for the support of the strings is characterized by the fact that the suspension system (15b) is moving parallel to the direction of the tailpiece (11) and the strings, without the tailpiece (11) being in contact with the top (17) of the guitar. This system consists of a sliding metallic rod (23) which bears six metallic tubes (26) anchored perpendicularly to the same and two metallic pins (24) bolted at their ends. The metallic tubes (26) with the metallic pins (24) are drawn in the respective holes (28, 25) of the metallic frame (21). Between the metallic rod (23) and the metallic frame (21), and externally to the metallic tubes (26), six metallic springs (27) are placed.

2. Tailpiece (11) for the support of the strings (12) on an acoustic archtop guitar (10), according to claim 1, characterized by the fact that the suspension system (15b) may he connected, through a metallic axis (22), with a metallic handle (13) moving between two fixed points (31) found on the metallic frame (21), turning thus the tailpiece (11) into a tremolo.

3. Tailpiece (11) for the support of the strings (12) on an acoustic archtop guitar (10), according to claim 1, characterized by the fact that the pressure of the strings and at times of the hand (tremor) is transferred, through the suspension system (15b), to the metallic frame (21) and from there to the side (14) of the guitar.

4. Tailpiece (11) for the support of the strings (12) on an acoustic archtop guitar (10), according to claim 1, characterized by the fact that the pressure of the strings is transferred to a metallic frame (21) through the six metallic springs (27).
